(19) United States
(12) Patent Application Publication
(10) Pub. No.: US 2010/0026600 A1
(43) Pub. Date: Feb. 4, 2010

(54) Radio Wave Detection Apparatus

(75) Inventor: Michael Stephen Jessup, Hampshire (GB)

Correspondence Address: CROWELL & MORING LLP;INTELLECTUAL PROPERTY GROUP, P.O. BOX 14300, WASHINGTON, DC, 20044-4300, US

(73) Assignee: Roke Manor Research Limited, Romsey ,Hampshire (GB)

(21) Appl. No.: 12/445,009

(22) PCT Filed: Oct. 8, 2007
(86) PCT No.: PCT/GB2007/050618

§ 371 Date: Apr. 9, 2009

(30) Foreign Application Priority Data
Oct. 16, 2006 (GB) 0620341.8
Jul. 20, 2007 (GB) 0714072.6

(51) Int. Cl. H01Q 21/20

(52) U.S. Cl. 343/799

(57) ABSTRACT

Radio wave detection apparatus includes an array of antenna elements which are able to receive radio waves which enter and leave the array. In this way antenna elements are able to cater for the detection of different types of polarisation from the one configuration.

This invention relates to apparatus for detection or transmission of radio waves and to apparatus that detects or generates radio waves and determines the direction of their source or directs the generated radio waves in a particular direction.

One known type of apparatus has a generally circular array of antenna elements about a centrally located circuitry. In order to detect the incoming radio waves it is necessary for the antenna elements to be compatible with the way in which the radio waves are polarised. It has been found that dipole elements inclined at an angle of forty-five degrees to the horizontal are most useful since they are able to gather radiation from circular polarised radio waves as well as radio waves which have a planar polarisation.

On any given side of the arrangement the dipoles will have an angle which will mean that they will not be compatible with some planes of polarisation.

The present invention arose from a realisation by the inventor that incoming radiation to a first side having a polarisation not compatible therewith will leave the array at the other side in a direction out from the array.

According to the invention there is provided an array of at least first and second antenna elements which antenna elements having at least first and second receptive directions for receiving radiation from a first direction into the array and a second direction out of the array.

Preferably the antenna elements are arranged to project out of a common plane. The preferred angle of projection is substantially forty five degrees to the plane.

The preferred form for the array is a circle although other shapes arrays may be used which may enclose or partially enclose a central portion. Preferably, the central portion does not include components which will inhibit the passage of radio waves.

A specific embodiment of the invention will now be described, by way of example only, with reference to the drawings in which:

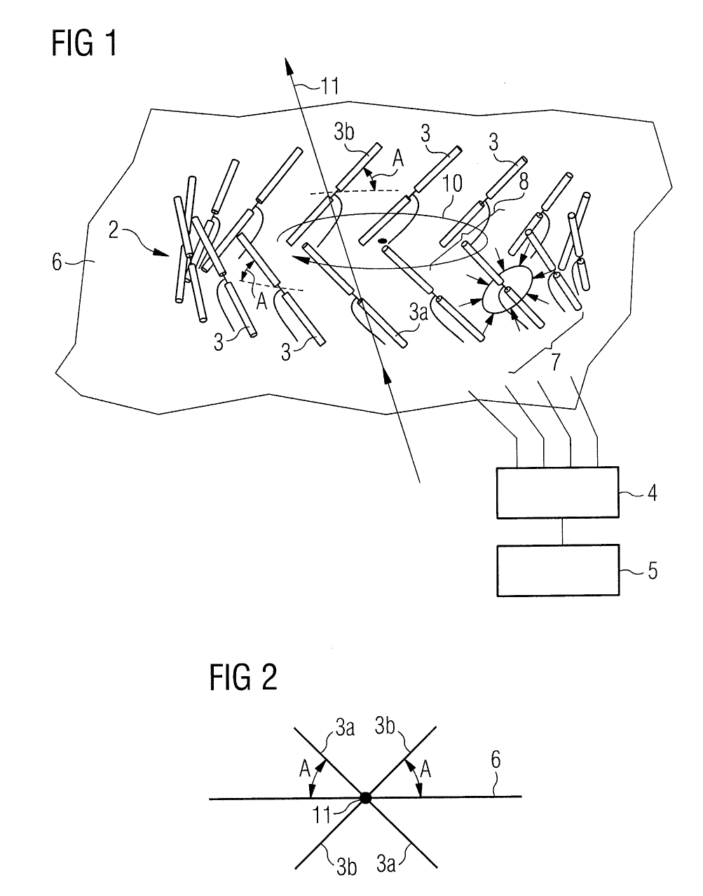

FIG. 1 shows apparatus for detecting the presence of radio waves and a direction to their source in accordance with the invention;

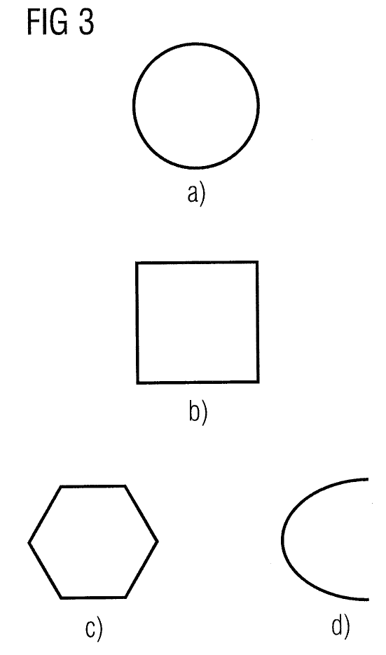

FIG. 2 shows two diametrically opposite antenna elements of an array in the apparatus of FIG. 1 from the point of view of an incoming radio wave;

FIG. 3 shows views from above of alternative antenna arrays; and

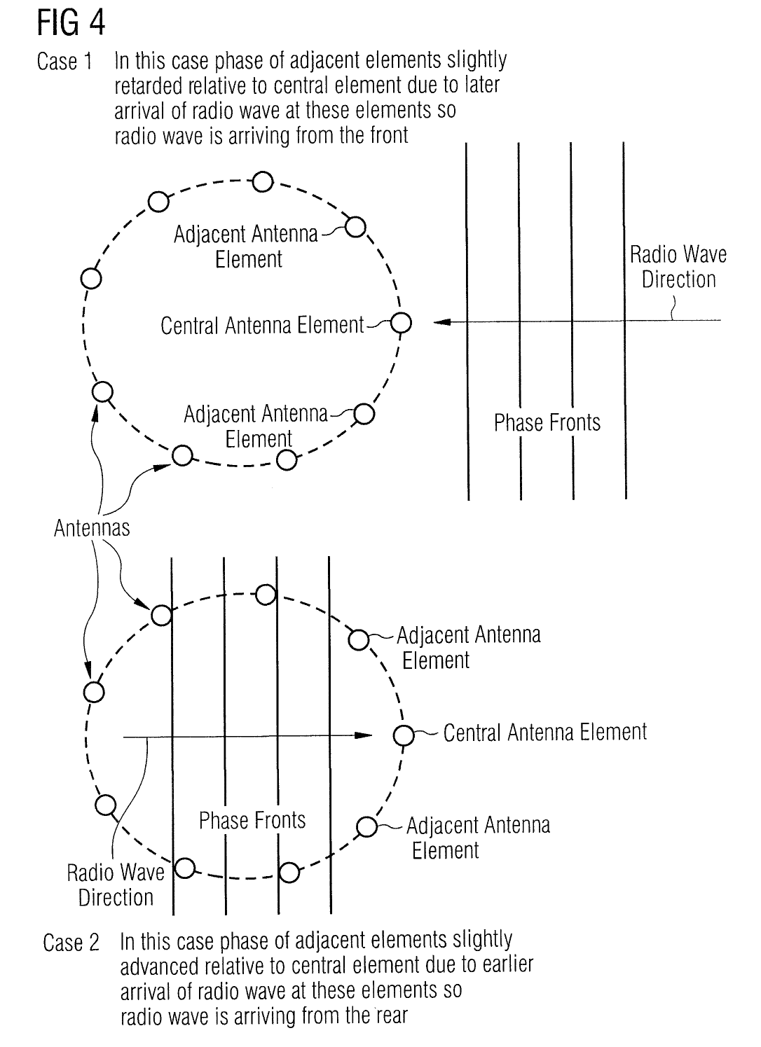

FIG. 4 shows wavefronts arriving at elements of the array.

As is shown in FIG. 1, apparatus for detection of radio waves 1 includes an antenna array 2 formed by an odd number of antenna elements 3 and signal processing 4 and a display 5.

The array 2 is generally annular in configuration with the antenna elements 3 projecting out of the plane 6 of the array by an angle A which in this case is 45 degrees. The antenna elements 3 are dipole elements able to receive radiation from 360 degrees about their axis and most importantly it should be noted that this means each element is capable of receiving radio waves incoming from directions outside of the array as depicted by arrows set 7 and also from directions from inside the array as depicted by arrow set 8.

The array 2 is shown in the figure as being centred about a point 9. This is a notional centre point for the purposes of explaining the properties of the array 2. It should be noted that opposite antenna elements are complimentary. Both are angled forward in the sense of a clockwise direction as depicted by arrow 10 to form the 45 degree angle A to the plane. However, when considered from the perspective of incoming radio wave 11 travelling into the array along its plane a first antenna element 3a which is the first element of the array on which the radio waves impinges is inclined in a first direction and the element 3b on the other side of the array is inclined in a second direction.

The situation is shown more clearly by FIG. 2 which shows a view along the line of propagation of the radio wave.

The significance of this is that when the propagation of the radio wave is not compatible with detection by the first element 3a it is likely to be compatible with the second element 3b. The radio wave is considered to be an incoming radio wave at element 3a but an outgoing radio wave at element 3b.

The antenna elements 3 provide outputs to the signal processing 4. This detects the crossing of an energy threshold and thus the presence or not of a signal. It will further include filters to filter the outputs to detect particular frequency. The direction of the incoming signal will be determined using phased array techniques of a known type to rotate the receiving beam. The presence of a radio wave source and its bearing from the apparatus is displayed on the display 5.

The plan form of the array is shown in FIG. 3a and it is annular. However, other forms of arrays may be used. These maybe rectangular or polygons and fully or as is shown in 3d partially enclosed.

It is necessary to detect the direction of the radio waves. That is to say to detect if the radio wave is one entering or leaving the array. This is illustrated in FIG. 4 in relation to a generally circular array. In the first case, Case 1 shown in the upper part of FIG. 4, the radio wave direction is from right to left. The phase fronts of the radio waves will impinge on a central antenna first and then moments later the adjacent antenna elements.

In Case 2, the radio wave direction is from right to left and in this case the phase front arrives at the adjacent antenna elements before the central antenna element.

Thus by determining the arrival time of wavefronts it is possible to determine the direction form which the radio waves are arriving. This determination is carried out by signal processing unit 4.

The antenna elements may be located at a separation dependent upon the wavelength of the radio waves to be detected. The inner part of the array is kept clear of radio wave affecting components to prevent blocking or interfering with any incident radio waves. The elements themselves may be held as an array in a block of dielectric material.

The antenna elements in the described embodiments are dipoles but may be other types of elements.

The antenna may also be used for transmission of radio waves.

1.-7. (canceled)

8. A radio wave detection apparatus comprising an array of antenna elements at least some of which elements being arranged to receive radio waves from a first set of directions from outside of the array and a second set of directions from inside the array and to provide output signals, wherein the antenna elements are arranged to detect radio waves of a first polarization state from the first set of directions and a second polarization state from the second set of directions.

9. The apparatus as claimed in claim 8, wherein the antenna elements project from a major plane of the array at an angle of substantially 45 degrees.

10. The apparatus as claimed in claim 8, wherein the elements of the array describe a substantially circular periphery.

11. The apparatus as claimed in claim 8, comprising means to compare the arrival of phase fronts of the radio waves at two or more elements to determine a direction of travel of the radio waves.

12. The apparatus as claimed in claim 8, wherein an inner part of the array is substantially without radio wave inhibiting components.
